(19) United States
(12) Patent Application Publication
(10) Pub. No.: US 2011/0112942 A1
(43) Pub. Date: May 12, 2011

(54) SYSTEM AND METHOD FOR PARTITIONING AIRTIME FOR DISTRIBUTION AND DISPLAY OF CONTENT AT RETAIL ESTABLISHMENTS

(75) Inventors: Robert I. Wolinsky, Fairfield, CT (US); Peter Goldring, Edgewater, NJ (US); Martin Amadio, Virgina Beach, VA (US); John J. Lunghi, Fairfield, CT (US)

(73) Assignee: Automated Media Services, Inc.

(21) Appl. No.: 13/007,112

(22) Filed: Jan. 14, 2011

Related U.S. Application Data
(62) Division of application No. 10/866,533, filed on Jun. 12, 2004.
Application No. 10/866,533 is a continuation of application No. 10/277,218, filed on Oct. 17, 2002, now abandoned.
(60) Provisional application No. 60/478,563, filed on Jun. 12, 2003.
(60) Provisional application No. 60/489,665, filed on Jul. 24, 2003.
(60) Provisional application No. 60/330,224, filed on Oct. 17, 2001.

(51) Int. Cl. G06Q 10/00; G06Q 30/00

(52) U.S. Cl. 705/30; 705/1.1

(57) ABSTRACT

A system and method for partitioning available airtime of electronic display equipment on a national and local level to encourage business establishments to utilize the electronic display equipment from a service provider. In partitioning the airtime, the service provider and business establishments that utilize the electronic display equipment of the service provider and/or media network may share in the airtime from booking and/or displaying content on the electronic displays. National level advertising enables content to be displayed at multiple, non-related business establishments (e.g., different grocery store food chains across the country). Local level advertising enables content to be displayed at individual business establishments (e.g., a single grocery store chain).

### CROSS REFERENCE TO RELATED APPLICATIONS

This application is a Divisional patent application of co-pending U.S. patent application Ser. No. 10/866,533 filed on Jun. 12, 2004, which claims priority from now expired U.S. Provisional Patent Application Ser. No. 60/478,563 filed Jun. 12, 2003; and now expired U.S. Provisional Patent Application Ser. No. 60/489,665 filed Jul. 24, 2003; which is also a continuation-in-part of U.S. patent application Ser. No. 11/600,498 filed Nov. 16, 2006 and now U.S. Pat. No. 7,742,950 issued on Jun. 22, 2010, which is a continuation of now abandoned U.S. patent application Ser. No. 10/277,218 filed Oct. 17, 2002, which claim priority from now expired U.S. Provisional Patent Application Ser. No. 60/330,224 filed Oct. 17, 2001; the entire teachings of which are herein incorporated by reference in their entirety.

### BACKGROUND OF THE INVENTION

1. Field of the Invention

The principles of the present invention are directed to advertising, and more particularly, but not by way of limitation, to a system and method for partitioning airtime between a media network and/or service provider and local affiliate, in the form of a business establishment, for distributing and displaying content.

2. Description of Related Art

Advertisers of goods and services continuously work to find the most effective media in which to advertise or promote their goods and services. Print media, such as newspapers and magazines, and broadcast media, such as radio, television, cable, satellite, and the Internet have all been used effectively by advertisers to advertise products and services that are or will be available for consumption. Of all forms of media that are traditionally used by advertisers, television has dominated due to the mass audience and persuasive nature of video. Within television, advertisers strive to find the most effective program, channel, time slot, among other parameters, that can provide the advertiser with the most targeted mass audience for its goods and services. For example, a diaper company generally tends to advertise during the day when housewives (i.e., most potential purchasers of diapers) are watching television.

As television has grown, so has the cost of advertising on this media. To better enable advertisers to determine audience size and demographics, a rating system has evolved in which measured viewership is a result from a small representative sample of a viewing audience. In part, based on sample data and various interpretations of the data, media network companies thereby set the price of their advertising airtime. However, in recent years, industry indicators point to diminishing effectiveness of television advertising. First, television has become an ever more fragmented market. No longer are there three broadcast channels from which viewers may choose as there are now literally hundreds of channels from which to choose on cable and satellite television, thereby reducing the potential for a mass audience. Second, the recent invention of digital recorders (e.g., TiVo®) enables the viewing audience to record television shows and simply skip over the advertisements. Third, trends have shown that the overall viewing audience for most programming has become smaller due to demographic changes, media proliferation, and other factors. And, while all these factors have become more evident, media networks (defined below) have increased the cost of their airtime to unjustifiable numbers based on traditional supply and demand valuations.

One factor that further concerns marketers is the inability to directly determine the effectiveness of television advertising. A marketer that advertises on television is hard-pressed to determine whether consumers who have seen the advertising are purchasing their goods or services as a direct or indirect result of the advertising. Still yet, when marketers purchase airtime for their ads, the cost is set based on the media network company's prediction of expected viewership. When viewership is reported, there is often an under-delivery of viewers, that often times causes the media network to provide an airtime credit to the advertiser. In an effort to have a more direct influence on consumers, marketers have used promotional advertising techniques directly in the business establishments that are actually selling their goods and services.

Traditionally, advertising in business establishments, such as retail stores, gas stations, members of a retail business association, movie theaters, etc., have been performed by way of promotional advertising. Promotional advertising is generally considered to include coupons, small signs, point-of-purchase (POP) displays, or other printed materials that are distributed and displayed on store shelves or other locations near products of the marketer or business establishments being sold in and by the business establishments.

More recently, business establishments have installed electronic displays, such as televisions or large format monitors, that enable an electronic image or video display of promotional advertisements and/or content. While the electronic displays have improved efficiency to a certain extent, improvement in revenue generation for the business establishment has only moderately improved for several reasons. First, the number of electronic displays is limited so that only a relative few marketers may participate in advertising on the electronic displays. Second, because of the excessive cost of having a staff maintain expensive display equipment, which is generally run off of a local server, cable, or satellite receiver, the electronic displays and associated equipment, are often owned and managed by a third party who sells ads to generate revenue and shares only a small portion with the business establishment. Third, because of the limited upside revenue potential in the existing business model in using the electronic displays, the business establishments are not motivated to further expand store populations of electronic displays. Fourth, due to the way this advertising is currently sold, these signs are generally sold as out-of-home media like billboards, which limits the revenue potential to relatively small advertising budgets, rather than attracting media planning revenue from television advertising budgets. Fifth, this process is disruptive to the business establishment's promotional revenue stream as the third party advertisement sales entity collects a portion of the revenue that was previously paid to the business by the marketer.

### SUMMARY OF THE INVENTION

To overcome the limitations of existing advertising equipment and revenue generation for business establishments, the principles of the present invention provide for a system and method for partitioning available airtime of electronic display equipment on a national and local level to encourage business establishments to utilize the electronic display equipment from a service provider and/or media network. In partitioning the airtime, the service provider and the business establishments that utilize the electronic display equipment may share in the available airtime on an electronic display network for displaying content (e.g., advertising content) on the electronic displays.

National airtime enables content to be displayed at multiple, non-related business establishments (e.g., different grocery store food chains across the country). Local level airtime enables content to be displayed at individual business establishments (e.g., a single grocery store chain). In sharing available airtime, a national network may be apportioned 60 percent of airtime of a network within a business establishment (i.e., local affiliate) and the business establishment may be apportioned the remaining 40 percent of the airtime. Revenue collected from selling respective airtime to advertisers may be collected for and/or by each of the national network and business establishments. In other words, a business establishment that sells the allotted airtime (e.g., 40%) to advertisers earns money for selling the airtime and the national network earns money for selling the allotted airtime (e.g., 60%) to advertisers.

According to the principles of the present invention, one embodiment includes a system for booking airtime for content to be displayed at business establishments is utilized. The system includes a computing system including a processor and memory. The processor executes software for enabling a user to book airtime for the content to be displayed at business establishments. The software, when executed by the processor, causes the processor to (i) form a first series of memory locations representative of available airtime segments for content to be displayed on electronic displays located in multiple, unrelated business establishments, (ii) form a second series of memory locations representative of available airtime segments for content to be displayed on the electronic displays located in at least one related business establishment of the unrelated business establishments is formed, (iii) load an identifier associated with a first content in at least one of the memory locations of the first series, (iv) load an identifier associated with a second content in at least one of the memory locations of the second series, and (v) distribute the content identified in the first and second series of memory locations to the respective business establishments for display on the electronic displays.

According to the principles of the present invention, another embodiment includes a system and method for apportioning airtime revenue between a network service provider and/or a media network company and business establishments. The method includes (i) managing a first playlist, including loading identifiers associated with first content to be displayed at multiple, non-related business establishments into the first playlist, (ii) managing a second playlist, including loading identifiers associated with second content to be displayed at least one related business establishment of the non-related business establishments into the second playlist, and (iii) apportioning the resulting revenue from airtime sales to the service provider and the at least one related business establishment based on a ratio formed by at least one metric of the content identified in the first and second playlists.

### BRIEF DESCRIPTION OF THE DRAWINGS

For a more complete understanding of the present invention, reference is made to the following detailed description taken in conjunction with the accompanying drawings wherein:

FIG. 1 is a block diagram showing an exemplary affiliation of a media network company (i) with a service provider or (ii) directly with business establishments;

FIG. 2 is a block diagram showing an exemplary affiliation of a network service provider/media network company having a affiliation with business establishments and an advertising agency and media planning company and a promotional in-store media planning service company;

FIG. 3 is an exemplary illustration of a fixture operable to display products and support electronic displays that may be operated by the business establishments of FIGS. 1 and 2;

FIG. 4 is a block diagram of an exemplary system for managing, distributing, and displaying content at business establishments;

FIG. 5 is an exemplary graphical user interface for a user to book airtime for content to be displayed at the business establishments;

FIG. 6 is a flow chart that provides an exemplary process for managing a partitioned network according to the principles of the present invention; and

FIG. 7 is a flow diagram describing an exemplary process for partitioning airtime between a network service provider and/or a media network and business establishment.

### DETAILED DESCRIPTION OF THE DRAWINGS

A media network is a company that produces programming content to draw an audience so that the media network can sell airtime during the programming content to advertisers or their agents. Programming content may include shows, movies, sporting events, concerts, news, commentary, etc. In general, an advertisement is defined as a notice designed to attract public attention or patronage. For the purposes of this application, content includes programming content and/or advertisements. The media networks may be established to broadcast the content over one or more media or technical networks, including television, cable, satellite, radio, Internet, etc. Examples of media networks include American Broadcast Company (ABC®), National Broadcast Company (NBC®), Cable News Network (CNN®), DirectTV®, etc. The media network may include any entity that advertises, creates advertising and/or programming content.

A network service provider is a company that provides services to a physical network or infrastructure that delivers signals to endpoints on the network to deliver content. For example, an internet service provider (ISP) is a company that provides access to the Internet for companies and individuals. Additionally, a cable service provider that provides cable services to homes is an example of a network service provider. In each of these and other technology cases, the network service provider performs the technical aspects of providing infrastructure, including distributing set top boxes, performing installations, performing wiring operations, and managing and distributing content to the subscribers, etc.

A broadcast media network is generally a television or radio network formed of a headquarters and network affiliates, which may or may not be owned by the media network, to distribute content over a broadcast network infrastructure. Cable networks are formed of a headquarters and local cable operators and/or cable companies, which may or may not be owned by the cable network. A satellite network replaces the cable company and communicates wirelessly with customers or subscribers. When media networks produce and distribute content that results in larger, and possibly more targeted audiences, marketers may be willing to pay higher costs for advertising airtime as more viewers are watching the programming and, therefore, may watch the advertisements and potentially purchase or participate in goods and services provided by the advertisers.

Traditionally, national media networks are allocated and may sell 60 percent of the available advertising airtime, commonly understood in the art as “national avails,” and have the local affiliates, cable or satellite companies sell 40 percent of the available advertising airtime, or “local avails”, around content provided by the media networks. For example, if the programming is a one-hour show, the programming may be played for 40 minutes and the advertising airtime may last for 20 minutes. Of those 20 minutes, 12 minutes may be sold by the media network and 8 minutes may be available to be sold by the local affiliate and/or cable/satellite company. It should be understood that other ratios may be similarly used and/or negotiated.

The principles of the present invention may utilize the systems and methods provided in co-pending U.S. patent application Ser. No. 11/600,498, which describes a communications system operable to manage and distribute content to electronic displays that are operated at business establishments, such as retail stores. A communications system that distributes the content to electronic displays via a local server or directly thereto may be utilized by the principles of the present invention.

A business establishment may form a business relationship with a media network, network manager/service provider and/or directly with any network so that content, that may or may not be associated with products sold at the business establishment, may be displayed on the electronic displays or other visual device. The business relationship between the media network headquarters and its local affiliates may be used as a model, whereby the local affiliate or cable/satellite company in the traditional structure is replaced by a business establishment or retailer. Consider for example, that a retail chain, such as Kroger®, is a local affiliate operating individual store locations that may control content being displayed at each store and on each electronic display, in one embodiment.

The retail chain acting as a local affiliate can itself become part of a larger network of local affiliates formed of multiple, non-related business establishments (e.g., a network formed of different retail chains) that, in essence, results in a national network that provides a mass viewing audience exactly where marketers desire to display their messages—at the point-of-purchase, where most consumer buying decisions occur. By forming this national network of multiple, non-related business establishments, advertisers and their agencies are able to advertise to a large viewing audience by purchasing national avails or local avails in a fashion compatible with traditional media planning practices. Enabling reach to an audience that is able to make instant purchasing decisions if the product or service is available at that business establishment ensures a marketer an opportunity to have its product purchased by each member of the audience (i.e., the shoppers).

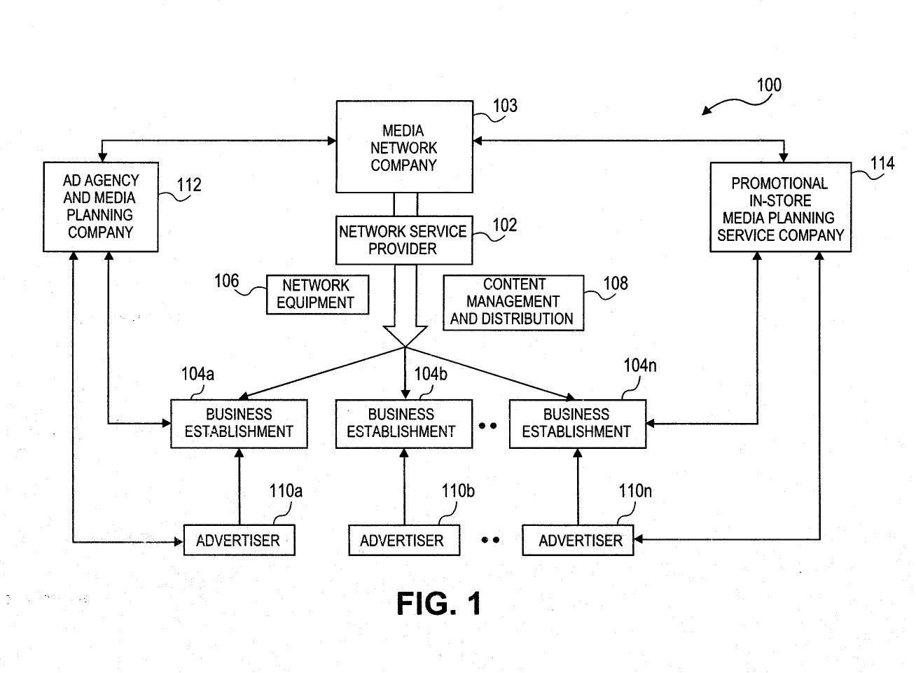

FIG. 1 is an exemplary block diagram 100 showing a network service provider 102, media network company 103, and affiliated business establishments 104a-104n (collectively 104). The media network company 103 may utilize infrastructure established by or in conjunction with the network service provider 102 and operated by the business establishments 104 or any other third party.

The media network company 103 may be a traditional broadcast company, such as NBC®, or a traditional cable network company, such as CNN®. The business relationship may have the network service provider 102, media network company 103, the business establishment itself or other third party provide the business establishments 104 with network equipment 106, and/or content management and distribution services 108. The network equipment 106, which operates in conjunction with a communications network (e.g., broadcast television and radio, satellite, cable, cellular, Internet, wide area networks, etc.), may include communication equipment, such as a satellite dish, server, local Ethernet, and electronic display devices (e.g., CRT, LED, LCD, plasma, etc.), which may communicate with the local server via the local Ethernet or be directly accessible via the communications network.

The business establishments 104 may thereby provide advertising services (i.e., sell airtime), directly or indirectly through third parties, such as an ad agency and/or media planning company 112 (“ad agency”) and/or promotional in-store media planning service company 114 (“promotional service company”), for advertisers 110a-110b (collectively 110). While the ad agency 112 and promotional service company 114 perform similar services, each is generally paid from different budgets from the advertiser 110, the advertising budget pays for the work of the ad agency 112 and the promotional budget pays for the work of the promotional service company 114.

The configuration of the business relationships allows the business establishments 104 to generate airtime revenue and potentially increase sales of products and services. In one embodiment, the business establishments 104 do not obtain the network equipment 106 via a capital expense, but rather pay a monthly service fee. Such a financial arrangement allows the business establishments 104 to treat the network equipment as an expense, which further financially helps the business establishments 104.

A partitioned network model may be established between the media network company 103, service provider 102, business establishments 104 and/or any other third party. The partitioned network model creates both national airtime spanning multiple, non-related business establishments 104 and local airtime belonging to one or more related business establishments 104a (e.g., a single retail chain store, such as Kroger®). By establishing a partitioned network model for sharing airtime for display of content on at least a portion of the electronic displays, the business establishments are provided with a financial incentive to acquire and utilize the network equipment. The partitioned network model is represented in FIG. 1 by having the ad agency 112 and/or the promotional service company 114 or any third party agent buy and sell or otherwise transact airtime for the advertiser 110 to display content on at least a portion of the electronic displays at the business establishments 104, thereby providing the media network company 103 and business establishments 104 with an airtime revenue base from national, regional, and local airtime sales. The airtime revenue base may be derived by apportioning airtime booking and/or display revenues between the media network company 103 and business establishment 104.

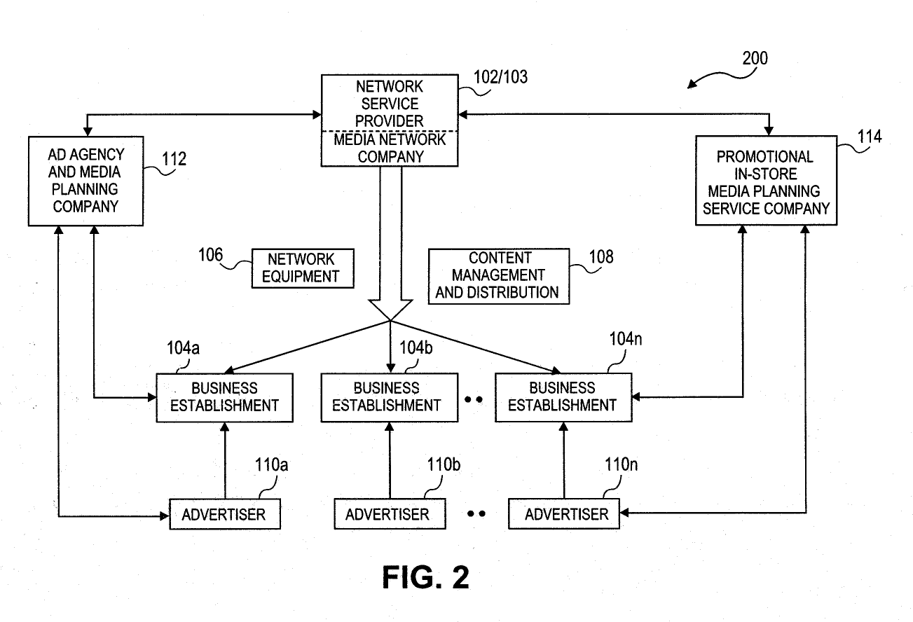

FIG. 2 is a block diagram showing an exemplary network model similar to that of FIG. 1, but the media network company 103 has been replaced by a network service provider 102. In one embodiment, the network service provider 102 is capable of providing national airtime on its affiliate network with the business establishments 104, the network service provider 102 itself operates as a media network company 103. In another embodiment, the media network company 103 may provide network services as does a network service provider and itself become a network service provider 102 that is capable of providing national airtime on its affiliate network with the business establishments 104.

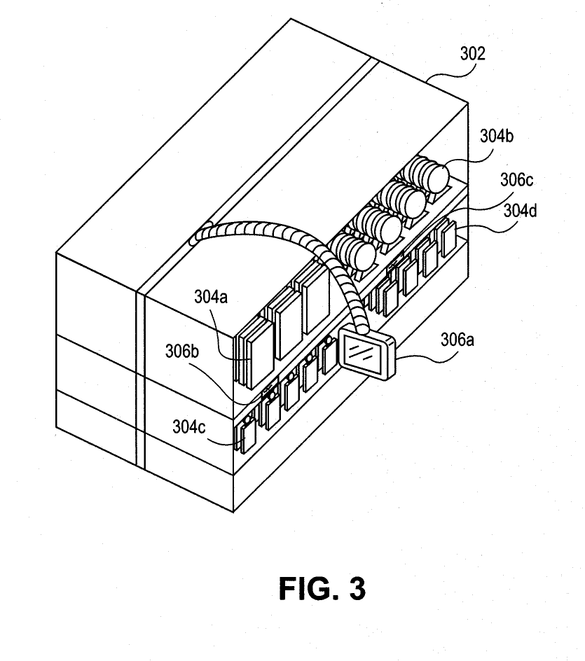

FIG. 3 is an exemplary illustration 300 of a fixture 302 operable to display products 304a-304d (collectively 304) and support electronic displays 306a-306c (collectively 306), which may operate in accordance with the description of the visual appliances as described in co-pending U.S. patent application Ser. No. 11/600,498 and configurations of hardware for mounting the visual appliances or electronic display devices to structures that support products (e.g., gondolas and shelves) or are otherwise part of the physical structure of a building (e.g., walls and poles) as described in co-pending U.S. patent application Ser. No. 11/600,635. The electronic display 306a may extend from the top of the fixture 302 into the line of sight of customers and may serve to display content and promotional messages. While the electronic displays 306b-306c may be mounted to the shelf-edges and may serve to display more targeted messages (e.g., promotional advertisements for products 304). Other locations may be utilized for electronic displays 306 to operate in line-of-sight locations including, but not limited to, walls, ceilings, poles, etc. Additionally, other location configurations and types of electronic displays 306 may be utilized by the business establishments 104 in accordance with the principles of the present invention.

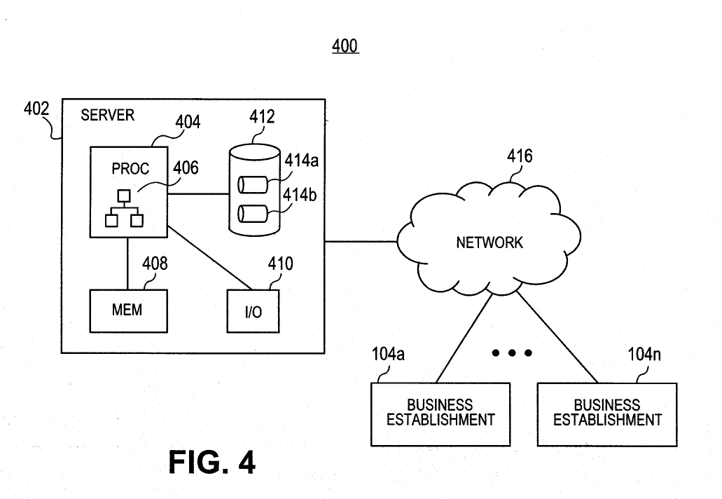

FIG. 4 is a block diagram of an exemplary system 400 for managing, distributing, and displaying content at business establishments. The system 400 includes a server 402 that includes a processor 404 operable to execute software 406 that performs a variety of functions to manage content to be displayed at the business establishments. The server 402 further includes a memory 408 for storing the software 406 during execution and data associated with the content. An input/output (I/O) unit 410 is also included for communicating information related to the content. A storage unit 412, such as a disk drive or other storage unit, includes one or more databases 414a-414b (collectively 414) or other data repository. It should be understood that the storage unit 412 may be included as part of the server 402 or in communication with the server 402 and remotely located from the server 402. The databases 414 may be utilized to store information generated by the software 406, such as playlists that are utilized to book or schedule airtime for content to be distributed and displayed on the electronic displays located in business establishments.

The server 402 may be in communication with a network 416, such as the Internet, for enabling users to remotely interact with the software 406. The users may be employees of the business establishments 104 or agents thereof. Alternatively, employees or agents of a network service provider 102 (FIG. 1 or 2) or media network company 103 (FIG. 1 or 2), ad agency 112 (FIG. 1 or 2) and/or promotional service company 114 (FIG. 1 or 2) may interact with the software 406 to book or purchase airtime for content to be displayed at the business establishments 104. The business establishments may include servers (not shown), the same or similar to the server 402, that are configured to receive one or more playlists and content from the server 402. The servers at the business establishments 104 may be configured to store and communicate the playlist(s) and video content to electronic displays to which the content is assigned to be played.

In operation, the software 406 may be used to generate one or more playlists that are used for booking airtime for content to be displayed in the business establishments 104. TABLES I and II are exemplary playlists that may be generated and managed by the software 406 for a user to book national airtime and/or local airtime, respectively.

TABLE I
National Content

| AD | LOC | Run-time | LENGTH |
|---|---|---|---|
| A | NAT'L | M-F | 0:06 s |
| B | NAT'L | M-F | 0:06 s |
| C | NAT'L | M-F | 0:06 s |
| D | NAT'L | M-F | 0:06 s |
| E | NAT'L | M-F | 0:06 s |
| F | NAT'L | M-F | 0:06 s |

TABLE II
Local Content

| AD | LOC | Run-time | LENGTH |
|---|---|---|---|
| G | BE 1 | M-F | 0:06 s |
| H | BE 1 | M-F | 0:06 s |
| I | BE 1 | M-F | 0:06 s |
| J | BE 1 | M-F | 0:06 s |

The playlists shown in TABLES I and II may be formed and stored in the memory 408 and/or storage unit 412 by the software 406 utilizing programming techniques as understood in the art. TABLE I represents a first series of memory locations or records that identify the content (e.g., A-F), locations for the content to be displayed (e.g., nat'l, business establishment (BE) 1), runtime for the content to be displayed (e.g., M-F), and length of the content (e.g., six seconds). Because each content segment is six seconds, a one-minute airtime playlist may include ten different content segments, where a content segment is considered a complete piece of content. The software 406 may further be utilized to distribute the content identified in the TABLES prior to the time booked for display at the respective business establishments 104.

The software 406 may further automatically adjust the playlists or programming wheel, generally known in the art as “the wheel”, based on the number of contents segments to be booked during a given time period. The wheel describes how often content is displayed to provide maximum consumer viewing. For example, if a national booking is only filled to 50 percent capacity, then the wheel may be automatically expanded to add timeslots for additional content to be displayed on a local level. Similarly, because the system according to the principles of the present invention may operate on a substantially real-time basis, if additional content is scheduled while a wheel is not completely filled, new content may be inserted into the wheel and distributed to the associated business establishments. The wheel may also be shortened or contract by removing content or simply not including the content in the first place, thereby increasing the number of times or frequency that the wheel is displayed per hour. It should be understood that the wheel may be increased or decreased at a central location or locally while being operated at distributed locations (e.g., business establishment).

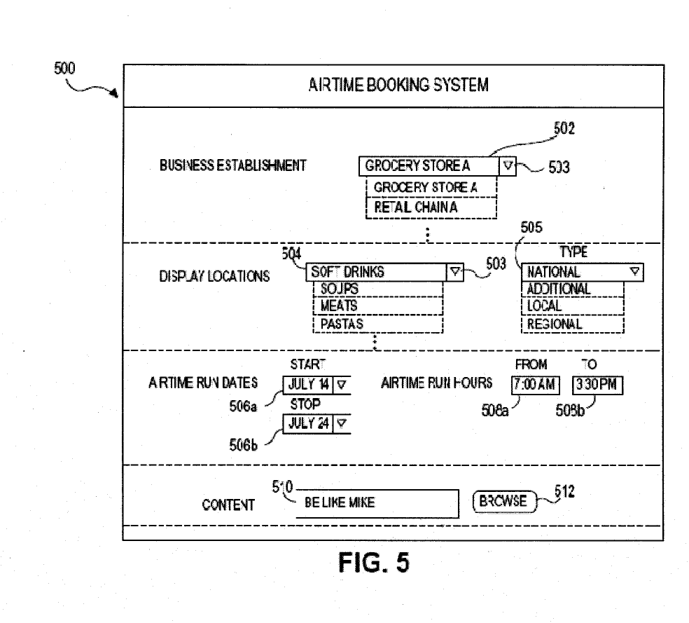

FIG. 5 is an exemplary graphical user interface (GUI) 500 for a user to book airtime for content to be displayed at the business establishments 104. The GUI 500 may be accessed via the Internet and displayed in a web-format or executed locally on an internal network. The GUI 500 may include a number of parameters for a user to enter for booking airtime for content to be displayed at a business establishment 104. A user may be an employee or agent for any of the participants shown in FIGS. 1 and 2.

Six parameters as shown in the GUI 500, including “business establishment”, “display locations”, “type of delivery”, “airtime run dates”, “airtime run hours”, and “content”. Associated with the “business establishment” parameter is a data entry field 502 that includes a drop-down menu button 503 for displaying predetermined potential business establishments (e.g., “Grocery Store A”, “Retail Chain A”, etc.) available for selection, which may contain various shopping and viewing data. Alternatively, the user may type the name of the business establishment or utilize another input technique to identify the business establishment in which to book airtime for displaying content. In this case, the user selected “Grocery Store A”, which is written in the entry field 502 as an identifier associated with a particular grocery store company. It should be understood that rather than using particular names of the business establishments 104 that codes or other identifiers may be utilized for selection of the particular business establishments.

The “display locations” parameter represents the location of the electronic displays that any of the participants of FIGS. 1 and 2 or any other user wishes to display content. For example, display locations may include “soups”, “meats”, “pastas”, etc., that represent sections or aisles in which the electronic displays 306 (FIG. 3) are located. For example, an advertiser who makes and sells soft drinks (e.g., Coca-Cola®) may advertise on one of the overhead displays 306a located in the soft drink section. Alternatively, another manufacturer, such as a maker of snacks, may wish to cross-advertise or promote in the soft drink section to remind purchasers of soft drinks to purchase snacks. In either case, an entry field 504 may receive a “soft drinks” entry thereby indicating that the advertiser wishes to display the content on an electronic display located in the soft drinks section or aisle of a store. In an alternative embodiment, rather than specifying the generic term for the section or aisle, the GUI 500 may use identifiers of a planogram (i.e., schematic drawings of fixtures that illustrate product placement within a business establishment) to enable the user to particularly select electronic displays 104 located at particular locations within the business establishments 104 to display the content.

A “content type” section enables a user to specify the type of content that the user wishes to run. The options shown include “national”, “local”, or “regional” and the user may enter the selection in the entry field 505. A selection of “national” will cause the content to be displayed in multiple, unrelated business establishments across the country, “regional” will cause the content to be displayed in multiple, unrelated business establishments in a local region (e.g., New England), and “local” will cause the content to be displayed in one or more related business establishments (e.g., Kroger®). Other regions or selections may be provided for a user to specify the locations in which to display the content. For example, types of stores (e.g., “drug stores”), traffic requirements (e.g., stores with 10,000 shoppers or more per day), etc., and certain other third party data (e.g., Nielsen data, In-Store Research Institute (IRI) data, U.S. census data, etc.) may be provided as selections for a user to select the location in which to display the content.

The GUI 500 further includes an “airtime run dates” section that enables a user to select dates to book airtime for content to be displayed. As shown, two entry fields 506a and 506b, “start” and “stop”, enable a user to enter a starting and stopping dates. Alternatively, other entry fields or indicators may be utilized to enable a user to enter dates for the content to run. For example, week, month, or year may be utilized to indicate to a user when to run the content. Additionally, “airtime run hours” may be selected in entry fields 508a and 508b so that more targeted content display may occur for advertising or promoting a product. For example, a baby food manufacturer may wish to run content during the times that mothers are shopping, such as 7:00 AM to 3:00 PM.

The GUI 500 further includes a “content” section in which the user is able to identify the content that is to be displayed at the selected airtime run dates. An entry field 510 may be utilized to enter the name or other identifier of the content. A browse soft-button 510 may be included that may be selected to enable a user to browse for the name or identifier of the content on a storage medium, such as a local or remote disk drive.

The GUI 500 provided is very basic and it should be understood that more sections and tools may be provided for a user to book airtime for content to be displayed on electronic devices 306 at business establishments 104. The number of combinations is almost limitless in terms of options and parameters for specifying how, when, where, and for what price to display content within business establishments 104. Further, one or more GUIs may be utilized to enable a user to book airtime for content to be distributed along the national or local channels provided by the affiliated network described in FIGS. 1 and 2. In other words, marketers (e.g., advertisers) or their agents who wish to book airtime on a national or regional level in multiple stores may utilize one GUI and marketers or their agents who wish to book airtime locally with a particular business establishment 104a may utilize a second GUI. The system may utilize passwords or other security measures to enable marketers or their authorized agents to access the airtime booking system.

Continuing with FIG. 3, two networks of electronic displays are shown, a first network including the shelf edge electronic displays 306b and 306c and a second network including the overhead or line of sight electronic displays 306a. The shelf edge electronic displays may be provided to the business establishment 104 to promote or sell “sign or promotional ad” space to marketers 110 under a subscription, rental fee agreement, or otherwise, as described in co-pending U.S. patent application Ser. No. 11/600,498. The line of sight electronic displays 306a may be partitioned as broadcast airtime as follows:
1. Local network partition airtime available to the business establishments 104 (i.e., local affiliate) or promotional in-store media planning service company 114 to sell to marketers 110, thereby serving as local airtime or “local avail”.
2. National network partition airtime available to the media network company 103 or ad agency and media planning company 112 to sell to marketers 110, thereby serving as network airtime or “national avail”.

The national avails and local avails may be allocated and sub-divided into segments to sell to marketers 110. In one embodiment, the media network company and/or network service provider 102/103 may retain 36 minutes of airtime per hour while 24 minutes of airtime per hour for the national network partition may be allocated to the local affiliate or business establishment 104 for the local network partition, therefore adhering to a standard 60/40 or 3:2 airtime inventory split regardless of frequency of play of content. The airtime revenue associated with the local affiliate's 24 minutes of airtime per hour from electronic displays 306a and the promotional ad space of the shelf-edge electronic displays 306c, may be retained by the local affiliate or business establishment 104 through sales to vendors and non-vendor advertisers or however the local affiliate sees fit to maximize the revenue potential of the overhead and shelf-edge visual appliance 306a-306c.

For the business establishments 104, the airtime apportioned thereto may be booked by the participants of FIGS. 1 and 2 or any other third party or otherwise so that the airtime is simply a revenue generating resource for the business establishments 104. For the network service provider 102 and/or media network company 103, the airtime apportioned thereto or national avail may be sold or auctioned to advertisers 110, ad agencies 112, and/or promotional service companies 114 or others.

The processor 404 of FIG. 4 may execute software to operate an algorithm that may be used to determine programming “wheel” construction. This or another algorithm further may be used to determine the number and placement of overhead and other line of sight electronic displays 306 (FIG. 3) in the business establishments. The variables in the algorithm may include average customer time spent in the business establishment, size and construction of the business establishment, customer traffic counts within the business establishment, customer flow patterns within the business establishment, customer visitation frequency per period, and a definitive run pattern exposure plan to insure to content providers the maximum advantage of accepted reach and frequency levels, as understood in the art. In one embodiment, a “wheel” or content loop may be five minutes long and include six, ten second content segments per minute so that there are 30 content segments played in that wheel. A shopper of a store who shops for 30 minutes may therefore have the opportunity to see a content segment up to six times. If the wheel is ten minutes long, 60 content segments are available and the shopper has an opportunity to view each ad segment three times.

The programming wheel may be composed of (i) network, regional/national, and spot avails, and (ii) local affiliate regional/local, and spot avail, in similar fashion to typical broadcast/cable television and radio trafficking procedures. Because the business establishment 104 allows the electronic displays 306 to be operated in their stores, they may control or have a say in the type of content that can be placed in the stores.

Continuing with FIG. 3, the shelf-edge electronic displays 306b-306c may be placed in close proximity to specific products 304. Because of this close proximity, the shelf-edge electronic displays 306b-306c may promote one product per shelf-edge electronic display and be dynamically optimized for shopping patterns during a given time period. In general, this cycle coincides with the weekly promotional activity of the local affiliate, but may operate by promoting products per cycle or off-cycle.

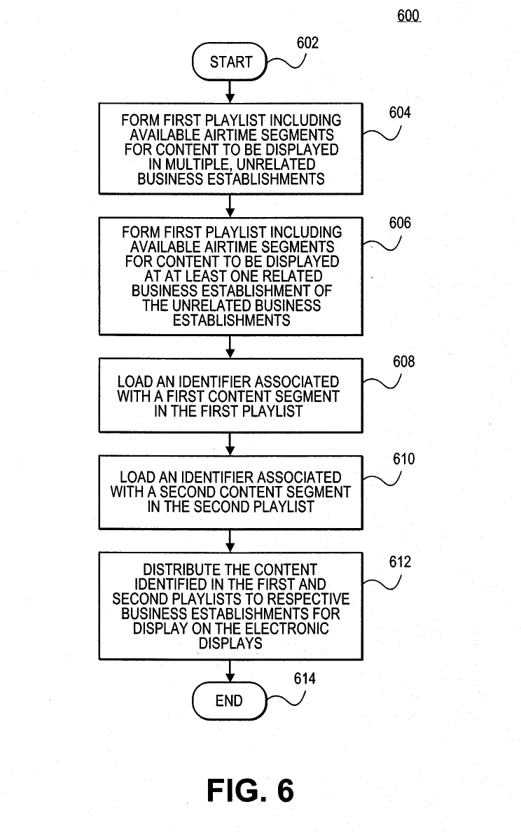

FIG. 6 is a flow chart that provides an exemplary process 600 for managing the partitioned network according to the principles of the present invention. The process 600 may be coded into the software 406 and be executed on the processor 404 of FIG. 4. The process starts at step 602. At step 604, a first playlist is formed that includes available airtime segments for content to be displayed in multiple, unrelated business establishments. The playlist may be formed of a series of memory locations that each form a record. At step 606, a second playlist that includes available airtime segments for content to be displayed at least one related business establishment of the unrelated business establishments may be formed. The at least one business establishment may include one or more stores of a single retail chain or be a member of an association (e.g., independent petroleum providers of an independent petroleum providers association).

At step 608, an identifier associated with one or more first content segments is loaded in the first playlist. At step 610, an identifier associated with one or more second content segment is loaded in the second playlist. The content identified in the first and second playlists to respective establishments for display on the electronic displays is distributed at step 612. The process ends at step 614.

In accordance with the principles of the present invention, the playlists may be the same or different lengths. For example, if the partitioned network is 60 percent national and 40 percent local, then the first playlist may be longer than the second playlist. More specifically, a ratio of the length of the first playlist to the second playlist may be approximately 3.2 (assuming that each time segment is equal). A third playlist may be formed for booking local airtime for content to be displayed in a second business establishment 104b. It should be understood that the playlists may simply be formed as part of a larger playlist and not be specifically located in a separate portions of memory.

There may be several different ways for distributing the content from a system point-of-view. First, the content identified in the playlists, national and local, may be organized at a server and distributed in full and servers and/or electronic displays 104 operating at the business establishments may accept the content identified to be played at the particular business establishments and disregard the content not identified to be played at the particular business establishments. Second, the content identified in the playlists may be individually distributed so that the content identified to be distributed locally or to particular business establishments are only distributed thereto. Third, if ad an content identified on a playlist has been previously distributed to the business establishments, but identified to be displayed again, that content is not redistributed to conserve bandwidth.

In booking the airtime, booking information, such as a list of business establishments 104 to display the content, display dates, display times, etc., may be communicated to a user via a network, such as the Internet. The user may be any individual authorized to book airtime for advertisers, media network company and/or business establishment.

In booking the airtime, at least three metrics may be utilized. First, the cost may be based on booking airtime for the content to be displayed over a certain period of time (e.g., between specified dates and times for content to be displayed).

Second, the cost of booking the airtime may be based on displaying the content (i.e., a certain number of displays costs a certain amount of money). To avoid under-delivery situations, the number of displays of the content may be adjusted based on the number of impressions that are made rather than simply a finite number of times the content is to be displayed (e.g., $10 per 1000 displays). An impression is the number of times individuals view the content. Because the network equipment provided to business establishments may be tied into the point-of-sale systems or other data collection devices of the business establishments as described in co-pending U.S. patent application Ser. No. 11/600,498 the number of impressions can be accurately determined by polling the point-of-sale system or device and/or collected third party data, such as Nielsen data, thereby using such data to determine the number of viewers or impressions during the time periods that content is being displayed. And, because there is feedback of actual numbers of people passing through the point-of-sale location (e.g., cash register) or other traffic measurement systems during the times of display of the content, the system may automatically avoid under or over-delivery of impressions on a substantially real-time basis (as opposed to traditional television techniques that rely on the collection of post viewing samples of viewership and reporting techniques that generally occur weeks/months after actual content airing). The system may operate to adjust by increasing or decreasing the duration, in terms of hours or days of view, frequency, or reach that the content is displayed by adjusting the playlist. The playlist may be adjusted centrally or locally.

It should be understood that while the principles of the present invention provide for an automatic adjustment of the duration for playing content on a substantially real-time basis based on feedback from a POS or other system in a business establishment, the principles of the present invention contemplate for a similar system to be based on actual viewership of television or other media if technology for measuring the viewership exists. For example, if set top boxes or satellite systems, for example, provide for feeding back the channel currently being watched by viewers, then the content distribution system may determine actual viewership and adjust the duration of playing content per a contract or other agreement to avoid under- or over-delivery of the content, thereby minimizing contract disputes between advertisers or other airtime purchasers and media network companies.

Third, the cost of booking airtime may be fixed based on a number of views or impressions. For example, an advertiser may pay a certain amount of money for a certain number of views (e.g., $1 per 1000 views up to $1 Million). It should be understood that other variations and metrics may be utilized to charge for booking airtime, such as a percentage of the sale of goods or fixed amount based on consumer action (e.g., increased products purchased).

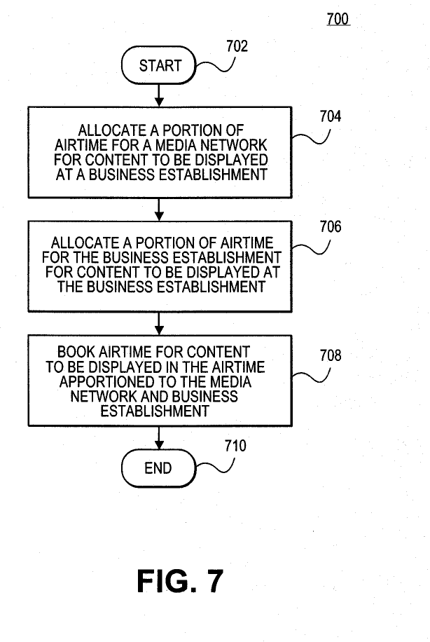

FIG. 7 is a flow diagram describing an exemplary process 700 for partitioning airtime between a media network and business establishment. The process starts at step 702. At step 704, a portion of airtime for the national avail content to be displayed at a business establishment is allocated. At step 706, a portion of airtime for the local avail content to be displayed at the business establishment is allocated. In one embodiment, the allocation of the airtime for the national avail is approximately 60 percent and the allocation of the airtime for the local avail is approximately 40 percent. Airtime for the content to be displayed in the airtime apportioned to the national avail and local avail is booked at step 708. In booking the airtime, any of the participants, advertisers 110, ad agency 204, promotional service company 206, and/or any third party may participate. In addition, the booking of the airtime may be performed via a graphical user interface as described hereinabove. The process ends at step 710.

Although a preferred embodiment of the method and apparatus of the present invention has been illustrated in the accompanying Drawings and described in the foregoing Detailed Description, it is understood that the invention is not limited to the embodiment disclosed, but is capable of numerous rearrangements, modifications, and substitutions without departing from the spirit of the invention as set forth and defined by the following claims.

What is claimed:

1. A method for booking airtime for content to be displayed at business establishments, said method comprising:
forming a first playlist including available airtime segments for content to be displayed on electronic displays located in multiple, unrelated business establishments;
forming a second playlist including available airtime segments for content to be displayed on the electronic displays located in at least one related business establishment of the unrelated business establishments;
loading an identifier associated with a first content segment in the first playlist;
loading an identifier associated with a second content segment in the second playlist; and
distributing the content identified in the first and second playlists to the respective business establishments for display on the electronic displays.

2. The method according to claim 1, wherein forming the first and second playlists includes forming the first and second playlists as being different lengths.

3. The method according to claim 2, wherein the lengths of first and second playlists form a ratio of approximately 3:2.

4. The method according to claim 1, further comprising forming at least one third playlist including available airtime segments for content to be displayed on the electronic displays located in at least one second related business establishment of the unrelated business establishments.

5. The method according to claim 1, wherein distributing the content to unrelated business establishments includes distributing the content to retail stores or members of an association.

6. The method according to claim 1, wherein distributing the content to the at least one related business establishment includes distribution to at least one retail chain store or members of an association.

7. The method according to claim 1, further comprising communicating booking information associated with the first playlist to be utilized for displaying a graphical user interface for entry of the identifier associated with the first content segment.

8. The method according to claim 7, further comprising communicating the booking information to an agent responsible for booking airtime for the content segment to be displayed.

9. The method according to claim 1, further comprising communicating booking information associated with the second playlist to be utilized for displaying a graphical user interface for entry of the identifier associated with the second content segment.

10. The method according to claim 9, further comprising communicating the booking information to an agent of the at least one of the related business establishments, advertising agency, promotional service company, or authorized agent.

11. The method according to claim 1, further comprising booking airtime for content segments to be displayed, wherein the booking includes loading the identifiers associated with the first and second content segments and applying dates and times for the content to be displayed.

12. The method according to claim 11, further comprising accounting for revenue generated for each of the multiple, non-related business establishments based on the booking and/or displaying of the content.

13. The method according to claim 1, further comprising scheduling airtime for the content to be displayed in at least one airtime segment of at least one of the first and second playlist having available airtime segments.

14. The method according to claim 1, further comprising merging the first and second playlists for distribution of the content identified therein to the at least one related business establishment.

15. The method according to claim 1, further comprising distributing the first and second content segments to the non-related business establishments.

16. The method according to claim 1, further comprising not distributing previously distributed first or second content segments that are scheduled for additional display on the electronic devices.

17. The method according to claim 1, further comprising automatically adjusting the length of the first and second playlists based on the number of identifiers of content segments loaded therein.

18. The method according to claim 1, further comprising generating a programming wheel that includes the identifiers loaded in the first and second playlists, the programming wheel thereby being customized for the at least one business establishment.

19. The method according to claim 18, further comprising distributing the programming wheel to the at least one business establishment.

20. The method according to claim 1, further comprising:
forming a third series of memory locations representative of available airtime segments for content to be displayed on electronic displays located in at least one second related business establishment of the unrelated business establishments;
loading an identifier associated with a third content segment in at least one of the memory locations of the third series;
generating a second programming wheel that includes the identifiers loaded in the first and third series of memory locations, the second programming wheel thereby being customized for the at least one second related business establishment of the unrelated business establishments; and
distributing the first and third content segments identified in the second programming wheel to the at least one second related business establishment for display thereat.

21. The method according to claim 20, further comprising distributing the programming wheel to the at least one second business establishment.
